(19) United States
(12) Patent Application Publication
(10) Pub. No.: US 2007/0244264 A1
(43) Pub. Date: Oct. 18, 2007

(54) Process and apparatus for preparation of thermoplastic polymer blends

(76) Inventors: James Emerson Granger, Dublin, OH (US); Dennis Kumor, Copley, OH (US); Hari Prasad Nadella, Copley, OH (US)

Correspondence Address: ExxonMobile Chemical Company;Law Technology, P.O. Box 2149, Baytown, TX, 77522-2149, US

(21) Appl. No.: 11/404,707

(22) Filed: Apr. 14, 2006

(51) Int. Cl. C08F 210/00; B01J 19/00; B01J 8/00

(52) U.S. Cl. 525/331.7; 524/445; 524/431; 525/343; 524/543; 422/131

(57) ABSTRACT

Provided for preparing thermoplastic polymer blends is (1) an apparatus comprising a grinder, a mixer, at least one material transfer device, a weigh scale, means for addition of additives to the mixer, a storage vessel, a processing device and means for feeding polymer to the processing device; and (2) a process comprising mixing a known amount of a first material with a desired amount of at least one additive based on a predetermined weight ratio of additive to first material to form individual batches of pre-mix, storing the pre-mix batches in a storage vessel, continuously feeding the pre-mix from the storage vessel to a processing device, adding a polymer stream to the processing device at a rate based on the first material feed rate to the processing device, optionally adding at least one vulcanizing agent stream to the processing device at a rate based on the polymer stream feed rate to the processing device and melt mixing all materials in the processing device to form a thermoplastic polymer blend.

### FIELD OF THE INVENTION

The present invention relates to a process and apparatus for preparation of thermoplastic polymer blends.

### BACKGROUND OF THE INVENTION

Thermoplastic polymer blends have found wide use in various fields such as car parts, appliance parts, hand-held utensils and other goods where a combination of durability and processability are valued. As used herein, “blend” shall mean a combination of two or more discrete components that may or may not be readily separable after combination, and the term “thermoplastic polymer blends” includes, without limitation, thermoplastic polyolefins, thermoplastic elastomers and thermoplastic vulcanizates. Thermoplastic polymer blends often are composed of a discrete phase of non-thermoplastic polymer dispersed in a matrix of thermoplastic polymer. The non-thermoplastic polymer phase is often added to provide physical characteristics not present in the thermoplastic polymer absent the additional phase. Additionally, if the non-thermoplastic polymer phase is composed of material with limited processability, dispersing the non-thermoplastic polymer phase in a matrix of thermoplastic polymer imparts at least some of the processability characteristics of thermoplastic polymers to the blends.

Thermoplastic elastomers (“TPEs”) are a special class of thermoplastic polymer blends and have a combination of both thermoplastic and elastic properties. It is generally known to produce TPEs by melt mixing and shearing a thermoplastic and an elastomer in an extruder; however, the method of preparation of the thermoplastic and elastomer before melt mixing and shearing can have dramatic effects on the efficiency of the production process and the uniformity and other characteristics of the final TPE composition.

Olefinic thermoplastic elastomers (thermoplastic polyolefins, or “TPOs”) are produced from an olefinic thermoplastic and a natural or synthetic rubber. Often, the rubber is supplied in bulk form called a “bale” or “block,” and must be reduced to a granular form before it may be efficiently melt mixed with the thermoplastic. Preparation of the rubber for melt mixing also may involve the addition of other materials to the rubber to prevent subsequent agglomeration of the rubber granules, to create a substantially free flowing mixture, improve its processability or aid in the formation of the TPO. The rubber and additive mixture is often called a pre-mix, and will be referred to as such herein. The amount of these additives to be mixed with the rubber is usually determined based on the amount of rubber fed to the preparation system (e.g., grinder), however, material holdup in rubber grinding devices, material loss in processing and other causes can lead to inaccuracies in the amount of rubber being processed and therefore to undesirable amounts (either low or high) of the additives fed to the extruder with the particulate rubber. Uneven distribution of the additives or the rubber makes it difficult to obtain a TPO with a uniform composition, thereby adversely affecting the TPOs characteristics.

Dynamically vulcanized thermoplastic elastomers (thermoplastic vulcanizates, or “TPVs”), as with traditional thermoplastic elastomers, have a combination of both thermoplastic and elastic properties. The thermoplastic vulcanizates are prepared by melt mixing and shearing at least one each of a thermoplastic polymer, a vulcanizable elastomer and a curing agent. The vulcanizable elastomer is dynamically cured during the shearing and mixing and is intimately and uniformly dispersed as a particulate phase within a continuous phase of the thermoplastic polymer. See, for example U.S. Pat. Nos. 4,130,535, 4,311,628, 4,594,390 and 6,147,160, which are incorporated by reference as if fully included herein.

In TPV preparation, in particular, obtaining a proper ratio of the cure agent to the vulcanizable elastomer is important so that a proper amount of vulcanization of the rubber phase occurs to provide the desired TPV characteristics. Consequently, it would be desirable to have a thermoplastic polymer blend production process that can accurately determine the relative amounts of material being processed so as to accurately meter the additives (processing, curing or others) and produce a thermoplastic polymer blend with superior characteristics, uniformity and consistency.

A known apparatus for preparation of TPVs comprises a grinder, additive airvey system, plough blender, ribbon blender mixer, blend feeder and an extruder. Each part of the apparatus is located on a separate level of a structure with the grinder located on the top level of the structure. Elastomer is raised to the top level of the structure by way of an elevator system and is placed in the grinder to be granulated. As the elastomer is granulated, a gravity feed system transfers the granules to a plough blender. After a given amount of elastomer has been granulated, the grinder is stopped. In the plough blender, the elastomer is blended with fixed amounts of additives, including clay, zinc oxide and stannous chloride to form a pre-mix. The amount of the additives mixed with the elastomer is determined by the amount of elastomer placed in the grinder, with no compensation for any material loss or holdup in the process. Determining the amount of additives in this manner often results in inaccurate amounts of additives being blended with the elastomer. Once blending in the plough blender is complete, the pre-mix is transferred by gravity to a ribbon blender, where it is kept homogenized and fluid. Gravity is again utilized to transfer the pre-mix to a weigh belt feeder that conveys and meters addition of the pre-mix to the extruder. A thermoplastic polymer stream is separately metered to the extruder, along with at least one vulcanizing agent stream, and optionally other cure agents and additives. The pre-mix and thermoplastic polymer are melt mixed in the extruder to form a thermoplastic polymer composition. The thermoplastic polymer composition is heated and sheared in the extruder in the presence of the vulcanizing agent to create a TPV. The TPV product is then extruded from the extruder. The batch pre-mix preparation and TPV extrusion process described in this paragraph necessitates alternating modes of operation and shutdown for parts of the apparatus and increases maintenance issues related to those parts.

Additionally, when a continuous-operation extruder is used to melt mix the thermoplastic and other materials to form the thermoplastic polymer composition, the batch pre-mix preparation process lacks both productive and economic efficiency. It would be desirable to have a process by which a batch pre-mix preparation process can be made more compatible with the continuous extrusion of a thermoplastic polymer composition.

### SUMMARY OF THE INVENTION

One aspect of the present invention provides an apparatus for preparing thermoplastic polymer blends comprising a grinder for granulating a material, a mixer, at least one material transfer device, a weigh scale, means for addition of additives to the mixer, a storage vessel, a processing device and means for continuously feeding one or more polymer streams to the processing device. In another aspect, the present invention further provides means for continuously feeding one or more vulcanizing agent streams to the extruder. When the material granulated in the grinder is a vulcanizable elastomer, as in an aspect of the present invention, the vulcanizing agent dynamically vulcanizes the elastomer phase of the thermoplastic polymer composition during melt mixing in the processing device to form a TPV. In yet another aspect, the mixer of the current invention is a low-shear, drum-type mixer capable of efficiently mixing materials of widely varying bulk densities.

The present invention also provides a process for producing thermoplastic polymer blends comprising the steps of granulating a first material, weighing the amount of granulated first material placed in a mixer, adding a desired amount of at least one additive based on a predetermined desired weight ratio of additive to first material, mixing the first material and additive to form a pre-mix, storing the pre-mix before further processing, continuously feeding the pre-mix at a known rate from storage to a processing device, adding at least one polymer stream to the processing device at a rate determined by the rate at which the first material is fed to the processing device and melt mixing and shearing the pre-mix and polymer (and optionally one or more other polymers, fillers or additives) in the processing device to form a thermoplastic polymer blend.

### BRIEF DESCRIPTION OF THE DRAWINGS

FIG. 1 is a schematic depiction of one embodiment of the apparatus of the present invention.

### DETAILED DESCRIPTION

The depicted embodiment is to be understood as illustrative of the invention and not limiting in any way. It should also be understood that the drawing is not necessarily to scale. In certain instances, details which are not necessary for the understanding of the present invention or which render other details difficult to perceive may have been omitted.

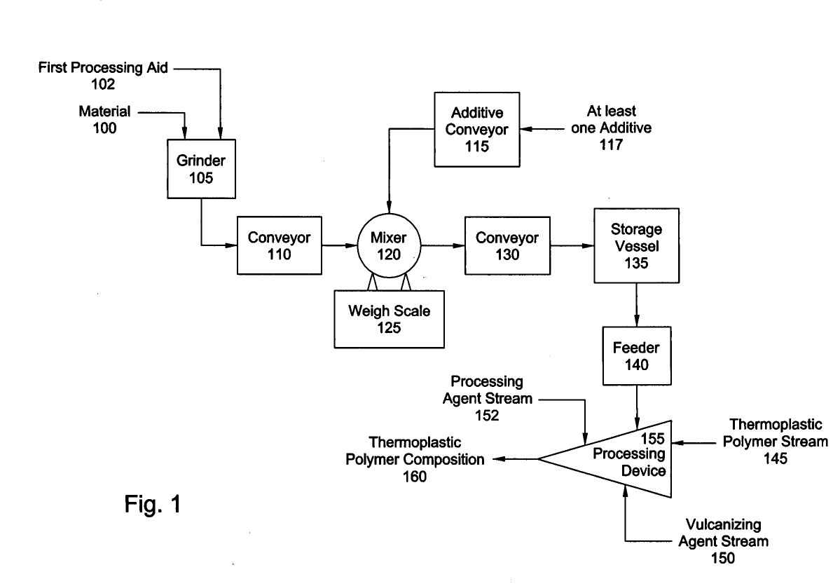

FIG. 1 is a schematic illustration of one embodiment of the apparatus for preparing thermoplastic polymer blends of the present invention. A material 100 in bale or block form is fed to a grinder 105 where the material 100 is granulated into granules. Alternatively, material 100 may be obtained initially in granular or particulate form and, in that case, grinder 105 may be omitted from the apparatus of the invention. The material 100 may be of any type suitable for melt mixing with a thermoplastic polymer to form a thermoplastic polymer composition. One such material is an elastomer, such as a natural or synthetic rubber. Optionally, a first processing aid 102 may be added to grinder 105 with material 100 to aid in the granulating process. First processing aid 102 may be of any type suitable for use with material 100, such as softeners, fillers, curing agents, stabilizers, processing aids or anti-agglomerating agents. Grinder 105 may be any type suitable for granulating bulk material, especially elastomers, such as a rotary grinder, granulator, rubber crusher, rubber cutter, ribbon cutter, rubber chipper or other means known to one of skill in the art, such as that provided by Hosokawa Micron Ltd. under the tradename Hosokawa Rietz rubber chopper.

Before exiting grinder 105, material 100, passes through a sieve screen (not shown) which restricts passage of material 100 to only those granules of a size smaller than the size sieve opening chosen for the screen. Typically, the sieve screen will have square or round openings with dimensions (side length for square openings or diameter for round openings) ranging from about two to about fifty millimeters each, or from about ten to about twenty five millimeters each, or from about five to about fifteen millimeters each, or from about ten to about fifteen millimeters each. As used herein and in the claims, a material's “particle size” will be deemed to be not greater than either, (i) depending on the shape of the sieve openings, the side or diameter dimension of the sieve openings through which the granule passed (if grinder 105 or similar equipment is employed) or (ii) the shortest cross-sectional dimension of a material obtained in a particulate form. During granulation, material 100 is preferably maintained at a temperature of from about 15 to about 100° C., more preferably 20 to 80° C., even more preferably 30 to 65° C., even more preferably 40 to 60° C. Upon exiting grinder 105, material 100, now in granular form, is transported by conveyor 110 for transport to mixer 120. As used herein, a conveyor may be any material transfer device known to one of skill in the art for transporting dry material, such as a vibratory conveyor, screw conveyor-type feeder, belt-type conveyor, airvey system, auger conveyor, pneumatic conveyor, bucket lift conveyor, disk pump, rotary conveyor or the like. The choice of each conveyor is within the skill of one in the art depending on the particular orientation of the apparatus and operating conditions. Further, a conveyor may be equipped to serve as a weigh, loss-in-weight, volumetric, gravimetric or mass flow type device as needed and known to one of skill in the art.

Mixer 120 receives a batch of material 100 and weigh scale 125 weighs the amount of material 100 in mixer 120. An additive conveyor 115 delivers an amount of at least one additive 117 to mixer 120. Conveyor 110 may also have a limited storage capacity for material 100, such that grinder 100 may continue operating during mixing and unloading of mixer 120. Such limited storage capacity could be implemented in a number of different ways, as would be well known to one of skill in the art. Additive 117, without limitation, can be one or more of the following: filler, oil, cure agent, vulcanization catalyst, glass bead, glass fiber, polymer fiber, nano-clay, carbon black or any other material that can assist in processing material 100 or impart desired physical characteristics to thermoplastic polymer composition 160. Additive 117 may be in crumb, pellet, granular, powder, liquid or solution form and can be added neat or as part of a concentrate or dilute carrier stream. The amount of each additive 117 is determined based on (i) the weight of the batch of material 100 in mixer 120 and (ii) a predetermined desired weight ratio of additive 117 to material 100. If first processing aid 102 is added to grinder 100, the measured weight of material 100 in mixer 120 should be adjusted to compensate for the amount of first processing aid 102 added to material 100. Mixer 120 mixes material 100 and additive 117 to form a pre-mix, an essentially homogeneous mixture of material 100 and additive 117. As used herein, a “mixer” can be of any type suitable for mixing materials of different bulk densities, such as a low-shear mixer, low-shear drum mixer, ribbon mixer, high speed impeller mixer, paddle mixer, fountain blender, cone blender, plough blender and drum tumbler, preferably a rotary drum mixer manufactured by Continental Products Corp. and sold under the trademark “Rollo-Mixer.” Preferably, the mixer used in the current invention exhibits little, if any, packing of powdery additives into the material 100 matrix mixed therein. If mixer 120 is a batch mixer, conveyor 110, preferably, has a storage capacity at least as large as the amount of material 100 granulated by grinder 100 during the time necessary for a pre-mix batch to be prepared and unloaded from mixer 120.

The pre-mix is transferred from mixer 120 by conveyor 130 to storage vessel 135. Storage vessel 135 has an effective storage volume at least as large as the effective storage volume of mixer 120. Effective storage volume means the volume of material equal to a portion of the total volumetric capacity of a vessel in which material can be held while maintaining processability (i.e. free flowing with uniform composition). For a mixer, the effective storage volume will be less than the total volumetric capacity of the mixer; while for a storage vessel, the effective storage volume is generally nearly equal to the total volumetric capacity of the storage vessel. Storage vessel 135 may be of any type suitable for storing bulk, dry materials, including a silo, tank, feed funnel, bin, hopper or tote. Preferably, storage vessel 135 has an effective storage volume greater than that of mixer 120, more preferably at least twice that of mixer 120. In one embodiment, storage vessel 135 is a second mixer that receives a batch of pre-mix and may continue the mixing process before the pre-mix is transferred to processing device 155 by feeder 140. The second mixer may be any type of “mixer” as more fully described above. When storage vessel 135 is a second mixer, storage vessel 135 preferably is equipped to operate on level control and is fitted with a continuous or semi-continuous discharge mechanism adapted to minimize variation in pre-mix bulk density, composition or particle size distribution while discharging and loading.

Feeder 140 is preferably a loss-in-weight or weigh type material transfer device such as a bulk solids pump, belt feeder or auger. This permits the amount of pre-mix being fed to the processing device 155 to be monitored on a continuous or periodic basis. Processing device 155 in one embodiment is a Banbury mixer, Buss co-kneader, Farrel continuous mixer, planetary extruder, single screw extruder, co- or counter rotating multi-screw screw extruder, co-rotating intermeshing extruder or ring extruder each of which extruders is equipped with one or more screws or rotors having kneading ability, and optionally, (i) one or more temperature controlled zones within the extruder capable of warming or cooling the material being processed by the extruder or (ii) a vent system to facilitate the removal of off-gases or volatile components while processing is ongoing.

The transfer of the pre-mix from storage vessel 135 to processing device 155 is advantageously continuous, but may be batch as well. At least one thermoplastic polymer stream 145 is also fed to processing device 155 at a rate determined by (i) the rate at which material 100 in the pre-mix is fed to processing device 155 and (ii) a predetermined desired weight ratio of each thermoplastic polymer stream 145 to material 100. Preferably, thermoplastic polymer stream 145 is added at or near the same position along the processing length of processing device 155 as the pre-mix. The pre-mix and thermoplastic polymer stream 145 are melt mixed and kneaded in processing device 155 to form thermoplastic polymer composition 160.

Optionally, one or more vulcanizing agent streams 150 may be fed to processing device 155 for mixing with thermoplastic polymer composition 160. When material 100 is an elastomer with reactive cross-linking sites, vulcanizing agent stream 150 vulcanizes material 100. Melt mixing and kneading of now-vulcanized material 100 and thermoplastic polymer stream 145 in processing device 155 for sufficient time and at sufficient temperature results in thermoplastic polymer composition 160 being a thermoplastic vulcanizate. Preferably vulcanizing agent stream 150 is added to processing device 155 at a point after the pre-mix and thermoplastic polymer stream 145 are added to processing device 155, more preferably at a point after which the pre-mix and thermoplastic polymer have formed a uniform molten blend. More preferably, vulcanizing agent stream 150 is added to processing device 155 at a point in the first 60% of processing device 155's processing length. Vulcanizing agent stream 150 may, alternatively, be melt fed or composed of a vulcanizing agent diluted in a process oil or mixed with a small amount of a thermoplastic polymer the same, similar to or compatible with the thermoplastic polymer in thermoplastic polymer stream 145.

When making a TPV with the current invention, the vulcanizable elastomer may be partially or fully cured. A fully cured TPV is typically achieved when the vulcanizing agent in vulcanizing agent stream 150 is added in an amount equal to from 0.2 parts vulcanizing agent to 100 parts elastomer depending upon the selection of vulcanizing agent, efficiency of mixing, operating temperature and the like. More preferably, the ratio is 3 to 100, more preferably 5 to 100, more preferably 8 to 100, more preferably 10 parts vulcanizing agent to 100 parts elastomer. The degree of cure can be measured by determining the amount of elastomer that is extractable from the thermoplastic vulcanizate by using cyclohexane or boiling xylene solvents as an extractant. Partially cured elastomer will have as much as 40 wt % (based on weight of curable rubber) extractable in solvent, and generally more than 10 wt % extractable. Fully cured elastomer will generally have less than 10 wt % extractable. In preferred embodiments, the elastomer has a degree of cure where less than 6 wt %, in other embodiments not more than 4 wt %, in other embodiments not more than 3 wt %, and in other embodiments not more than 2 wt % is extractable by cyclohexane at 23° C. in 48 hours.

Optionally, one or more processing agent streams 152 may be fed to processing device 155 to aid in processing thermoplastic polymer composition 160. Processing agent stream 152 may be an oil, cure agent, vulcanization catalyst or any other material that can assist in vulcanization or processing of, or impart desired physical characteristics to, thermoplastic polymer composition 160. Processing agent stream 152 may be added at any point along the operational length of processing device 155, preferably at a point within the first 80% of processing device 155's operational length.

As noted above, an alternate embodiment of the inventive apparatus, material 100 is obtained in granular or particulate form, thereby eliminating the need for grinder 105. In this embodiment, the granular or particulate form of material 100 would be added directly to mixer 120 before weighing.

A process for preparation of thermoplastic polymer blends according to the present invention involves first, obtaining a quantity of first material granules. If the granules of first material are of a size greater than that needed for use in the process, the first material can be ground, cut or granulated to the necessary particle size by any suitable means, including rotary grinders, granulators, rubber crushers, rubber cutters, ribbon cutters or other means known to one of skill in the art. When granulated, the first material preferably can pass through a sieve screen with sieve holes sized according to process needs, such sizing within the skill of one in the art. Once in granular form, the first material granules will have particle size of from two to about fifty millimeters each, or from about ten to about twenty five millimeters each, or from about five to about fifteen millimeters each, or from about ten to about fifteen millimeters each. Optionally, a first processing aid may be added to the grinder with the first material to aid in the granulation process. The first processing aid may be of any type suitable for use with the first material, such as softeners, fillers or anti-agglomerating agents.

The first material may be transferred to a first mixer from the source of first material granules, such as the grinder or, if the first material was obtained in an acceptable granule form, such as elastomer pellets, particles, granules or crumbs, from a storage vessel. The first mixer can be any mixer capable of efficiently mixing materials of different bulk densities, such as a low-shear mixer, a low-shear drum mixer, ribbon mixer, high speed impeller mixer, plough mixer, paddle mixer and drum tumbler. Preferably, the first mixer is a low shear mixer, more preferably, a low-shear drum mixer, even more preferably a rotary drum mixer manufactured by Continental Products Corp. and sold under the trademark “Rollo-Mixer.” The weight of first material granules placed in the first mixer is determined by a weigh scale. In a preferred embodiment, the weigh scale is a digital weigh scale. More preferably, the weigh scale is a programmable for operation and is integrated with the first mixer. At least one additive is also placed in the first mixer and mixed with the first material to form a pre-mix.

The at least one additive may be a filler, oil, cure agent, vulcanization catalyst or any other material that can assist in processing the first material or impart desired physical characteristics to the thermoplastic polymer blend. In one embodiment, the at least one additive is three additives, preferably zinc oxide, clay and stannous chloride. The amount of any additive mixed with the first material may be determined by (i) the weight of first material transferred to the first mixer and (ii) a predetermined weight ratio of additive to first material. For example, when the first material is an EPR or EPDM rubber and the additives are clay, zinc oxide and stannous chloride, the predetermined weight ratio of additives to rubber, respectively, may be 42:100, 2:100 and 1.26:100. The predetermined weight ratios of clay, zinc oxide and stannous chloride to rubber, however, may fall into other ranges, for instance from 3:100 to 1:1 for clay, 0.5:100 to 1:10 for zinc oxide and from 0.2:100 to 1:50 for stannous chloride. Because the granulating and transfer of the first material to the first mixer will often result in some material loss, through holdup in the grinder or otherwise, determining the weight of the first material actually transferred to the first mixer permits an accurate determination of the amount of each additive to be mixed with the first material. If a first processing aid is used, the amount of first processing aid added to the grinder is accounted for in the calculation of the amount of additive mixed with the first material. If the first processing aid is present at a concentration ratio less than the error margin of the weigh scale, the amount of first processing aid may be ignored when determining the desired amount of additive mixed with the first material.

In one embodiment, the pre-mix is then transferred to a storage vessel to await further processing before being fed to a processing device. In an alternate embodiment, the pre-mix may be transferred directly from the first mixer to the processing device's feed throat. The process of the current invention up to this stage can be described as a batch-type process. Examples of the processing device used in the present invention are a Banbury mixer, Buss co-kneader, Farrel continuous mixer, planetary extruder, single screw extruder, co- or counter rotating multi-screw screw extruder, co-rotating intermixing extruder and ring extruder each of which extruders is equipped with one or more screws or rotors having kneading ability, and optionally, (i) one or more temperature controlled zones within the extruder capable of warming or cooling the material being processed by the extruder or (ii) a vent system to facilitate the removal of off-gases or volatile components while processing is ongoing. As is known to those of skill in the art, further processing of the pre-mix may take one or more of several forms, including, but not limited to, dynamic vulcanization, grafting and compatibilization.

A thermoplastic polymer stream may also be fed to the processing device at one or more points. The thermoplastic polymer stream is fed to the processing device at a rate determined by (i) the rate at which the first material in the pre-mix is fed to the processing device and (ii) a predetermined desired weight ratio of thermoplastic polymer to first material. For example, in one embodiment, when the first material is an EPR or EPDM rubber and the thermoplastic polymer is polypropylene, the desired weight ratio of thermoplastic polymer to first material is from 1:50 to 6:1. The thermoplastic polymer and pre-mix are then melt mixed, kneaded and sheared in the processing device to form a thermoplastic polymer mix.

In one embodiment, the first material is an elastomer. As used herein, reference to an elastomer includes a mixture of two or more different elastomers. Exemplary elastomers for use with the present invention include the following: EPR rubber, EPDM rubber, butyl rubber, natural rubber, synthetic homo- or copolymers of at least one conjugated diene with an aromatic monomer, such as styrene, or a polar monomer such as acrylonitrile or alkyl-substituted acrylonitrile monomer(s) having from 3 to 8 carbon atoms, synthetic polyisoprene, polybutadiene elastomer, styrene-butadiene elastomer and mixtures thereof. As used in the specification and claims, the term butyl rubber includes copolymers of an isoolefin and a conjugated diolefin, terpolymers of an isoolefin with or without a conjugated diolefin, divinyl aromatic monomers and the halogenated derivatives of such copolymers and terpolymers. Non-polar elastomers are preferred; polar elastomers may be used but may require the use of one or more compatibilizers, as is well known to those skilled in the art.

Optionally, one or more vulcanizing agent streams may be fed to the processing device. When the first material is an elastomer with reactive vulcanization sites, the vulcanizing agent serves to cross-link the elastomer in the pre-mix when the pre-mix is processed in the processing device. The elastomer may be partially or fully cured during this process. Additionally, some curing of the elastomer may take place after the at least partially vulcanized thermoplastic polymer blend exits the processing device. When used in this manner, the present invention is suitable for producing thermosets, including, but not limited to, EPR and EPDM, in pellet or other form. When both a thermoplastic polymer stream and a vulcanizing agent stream are used, the process of the present invention is suitable for making dynamically cured thermoplastic vulcanizates.

Optionally, one or more processing agent streams may be fed to the processing device. The processing agent may be an oil, cure agent, vulcanization catalyst, lubricant (such as N,N′-Ethylenebisstearamide (sold commercially under the tradename Kemamide® W-39) and silicone fluids) or other material that will impart desirable physical characteristics to the thermoplastic polymer blend. When the processing agent is an oil and the first material an elastomer, the desired weight ratio of oil to elastomer may range from 5:1 to 1:10.

The thermoplastic polymers that may be used in the present invention are solid plastic resin materials. Preferably, the resin is a crystalline or a semi-crystalline polymer resin, and more preferably is a resin that has a crystallinity of at least 10 percent as measured by differential scanning calorimetry. When the present invention is employed to make TPVs, the melt temperature of these resins should generally be lower than the decomposition temperature of the elastomer. Both polar and non-polar polymers can be utilized in the current invention. As used herein, reference to a thermoplastic polymer or thermoplastic resin or engineering resin includes a mixture of two or more different thermoplastic polymers or a blend of one or more compatibilizers and two or more different thermoplastic polymers.

Exemplary thermoplastic polymers include crystallizable polyolefins, polyimides, polyamides (nylons), polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, and polyurethanes. The preferred thermoplastic resins are the crystallizable polyolefins that are formed by polymerizing α-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. For example, known polyethylene homo- and copolymers having ethylene crystallinity are suitable. Isotactic polypropylene and crystallizable copolymers of propylene and ethylene or other C₄-C₁₀ α-olefins, or diolefins, having isotactic propylene crystallinity are preferred. Copolymers of ethylene and propylene or ethylene or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof are also suitable. These will include reactor polypropylene copolymers and impact polypropylene copolymers, whether block, random or of mixed polymer synthesis. As used herein, the term “copolymer” means a polymer comprising two or more monomer derived units.

Transfers of first material, pre-mix or additive may be by any suitable means, such as a vibratory conveyor, screw conveyor-type feeder, belt-type conveyor, airvey system, auger conveyor, pneumatic conveyor, bucket lift conveyor, disk pump, rotary conveyor or any other means known to one of skill in the art. Further, a conveyor may be equipped to serve as a weigh, loss-in-weight, volumetric, gravimetric or mass flow type device as needed and known to one of skill in the art. The invention further envisions that material transfer devices may be simply chutes or hoppers. Through proper physical arrangement of the process or apparatus, gravity may be employed, together with a chute or hopper, to transfer material from one part of the process or apparatus to another. Preferably, the material transfers from the first mixer to the storage vessel and from storage vessel to feeder are accomplished by gravity and chute. Most material transfers of the invention preferably occur in a manner that also acts as a temporary storage means, holding a quantity of the transferred material so that the effects of upsets in the process upstream or downstream of the material transfer device may be minimized and continual operation of the downstream process permitted while repairs are effectuated. In one embodiment, at least one of the material transfer devices of the present invention has a storage capacity of up to 5% by weight of a pre-mix batch, in another up to 10%, in yet another up to 15%, and in another up to 25% or more. In one embodiment, it is not desired that the material transfer to the processing device be capable of holding a quantity of material so that material flow to the processing device is continuous and uninterrupted.

In one embodiment, the storage vessel has an effective storage volume greater than that of the first mixer. In another, the effective storage volume of the storage vessel is at least twice that of the first mixer. When the storage vessel has an effective storage volume greater than that of the first mixer, the batch portion of the present invention process may be repeated more than once before the rest of the process is initiated to provide a buffer against upstream process upsets that would affect material supply to the processing device and potentially create inconsistencies in composition of the thermoplastic polymer blend.

Vulcanizing agents, or cure agents (vulcanizing agent plus vulcanization catalysts and coagent(s)) that may be used in the invention for cross-linking, or vulcanizing, the elastomers can be any of those known to those skilled in the art for processing vulcanizable elastomer, or more particularly, thermoplastic vulcanizates, including silicon hydrides, phenolic resins, peroxides, free radical initiators, sulfur, zinc metal compounds and the like. The named curatives are frequently used with one or more coagents that serve as initiators, catalysts, etc. for purposes of improving the overall cure state of the elastomer. The curatives may be added in one or more locations, including the first mixer, the feed hopper of the processing device, or directly into the processing device after melt mixing has begun. For more information see, S. Abdou-Sabet, R. C. Puydak, and C. P. Rader in Dynamically Vulcanized Thermoplastic Elastomers, 69(3) RUBBER CHEMISTRY AND TECHNOLOGY (July-August 1996). The curative systems of U.S. Pat. Nos. 5,656,693, 6,147,160, 6,207,752, 6,251,998 and 6,291,587 are suitable.

Fillers can be inorganic fillers, such as calcium carbonate, clays, silica, talc, titanium dioxide, or organic carbon black, reinforcing glass or polymeric fibers or microspheres, and any combinations thereof. Fillers may be added at various points during the process, as would be clear to one of skill in the art, including, but not limited to the grinder, the first mixer or the second mixer.

Oils, whether extender or process, are particularly useful as plasticizers in the reactive processing of the invention. Elastomer extender and process oils have particular ASTM designations depending on whether they fall in a class of paraffinic, naphthenic, or aromatic process oils derived from petroleum fractions. The type of process oils utilized will be customarily used in conjunction with the elastomer component. The ordinary skilled person will recognize which type of oil should be utilized for a particular elastomer and thermoplastic combination.

One advantage of the present invention is its ability to convert the batch rubber granulation and pre-mix process to a continuous extrusion process. This is accomplished by making up individual batches of pre-mix, storing the individual batches in a storage device, and continuously feeding the pre-mix from the storage device to the processing device. Preferably, the rate at which the individual batches of pre-mix are made up and transferred to the storage device is at least as high as the rate at which the pre-mix is fed to the processing device. “Continuous” or “continuously,” as used in the claims, means “uninterrupted operation for a period of time longer than that required to create an individual batch of pre-mix.”

In another embodiment, this invention relates to:
1. An apparatus for preparing thermoplastic polymer blends comprising: a first mixer adapted to contain a quantity of first material granules; a weigh scale adapted to weigh the amount of the first material granules in the first mixer; means for adding a desired amount of at least one additive to the first mixer to form a batch of a pre-mix of first material granules and the at least one additive, the desired amount of the at least one additive being based on the weight of the first material granules in the first mixer and a predetermined desired weight ratio of the at least one additive to the first material granules; a storage vessel; a batch transfer device operably connected at a first end to the first mixer and at a second end to the storage vessel, the batch transfer device adapted to transfer the pre-mix from the first mixer to the storage vessel; a processing device; and a continuous feeder operably connected at a first end to the storage vessel and at a second end to the processing device, the continuous feeder adapted to continuously feed the pre-mix from the storage vessel to the processing device at a predetermined rate.
2. The apparatus of embodiment 1 further comprising: a grinder adapted to granulate a first material to obtain at least a portion of the quantity of first material granules.
3. The apparatus of embodiment 2 further comprising: a granular material transfer device operably connected at a first end to the grinder and at a second end to the first mixer, the granular material transfer device adapted to transfer the quantity of first material particles from the grinder to the first mixer.
4. The apparatus of any of the preceding embodiments, wherein the storage vessel is a second mixer and any of the first and second mixers is a drum mixer.
5. The apparatus of any of the preceding embodiments, further comprising: means for continuously feeding one or more polymer streams to the processing device, each of the polymer streams being fed into the processing device at a rate based on the rate at which the first material granules in the pre-mix are being fed into the processing device and a predetermined desired weight ratio of each polymer to first material granules.
6. The apparatus of any of the preceding embodiments, wherein the first material is an elastomer.
7. The apparatus of any of the preceding embodiments, further comprising: means for feeding at least one vulcanizing agent stream to the processing device, each of the vulcanizing agent streams being fed into the processing device at a rate based on the rate at which the first material granules in the pre-mix are being fed into the processing device and a predetermined desired weight ratio of each vulcanizing agent to first material granules and wherein the elastomer is at least partially cured.
8. The apparatus of any of the preceding embodiments, further comprising: means for feeding at least one processing agent stream to the processing device, each of the processing agent streams being fed into the processing device at a rate based on the rate at which the first material granules in the pre-mix are being fed into the processing device and a predetermined desired weight ratio of each processing agent to first material granules.

In yet another embodiment, the invention relates to:
9. A process for preparation of thermoplastic polymer blends comprising: transferring a quantity of first material granules to a first mixer; determining the weight of the first material granules in the first mixer; calculating the desired amount of at least one additive based on (i) the weight of the first material granules in the first mixer and (ii) a predetermined desired weight ratio of the at least one additive to the first material granules; adding the desired amount of the at least one additive to the first material granules in the first mixer; mixing the first material granules and the at least one additive in the first mixer to obtain a batch of a pre-mix; transferring the pre-mix from the first mixer to a storage vessel; continuously feeding the pre-mix from the storage vessel to a processing device; continuously feeding at least one polymer stream to the processing device, the at least one polymer stream being fed at a rate based on (i) the rate at which the first material granules in the pre-mix are being fed to the processing device and (ii) a predetermined weight ratio of polymer to first material granules; and continuously blending the pre-mix and the at least one polymer stream in the processing device to form a thermoplastic polymer blend.
10. The process of embodiment 9, further comprising: granulating a first material to obtain a quantity of first material granules.
11. The process of embodiments 9 or 10, wherein the first material is an elastomer.
12. The process of embodiments 9, 10 or 11, wherein the at least one polymer stream is selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.
13. The process of embodiments 9, 10, 11 or 12, wherein the storage vessel is a second mixer and any of the first and second mixers is a drum mixer.
14. The process of embodiments 11, 12 or 13, further comprising: feeding at least one vulcanizing agent stream to the processing device, the at least one vulcanizing agent stream being fed at a rate based on (i) the rate at which the first material granules in the pre-mix are being fed to the processing device and (ii) a predetermined weight ratio of vulcanizing agent to first material granules.
15. The process of embodiment 14, further comprising: heating the thermoplastic polymer blend in the processing device to obtain an at least partially-cured thermoplastic elastomer.

The above description is intended to be illustrative of the invention, but should not be considered limiting. Persons skilled in the art will recognize that various modifications may be made without departing from the spirit and scope of the invention. Accordingly, the invention will be deemed to include all such modifications that fall within the appended claims and their equivalents.

What is claimed is:

1. Apparatus for preparing thermoplastic polymer blends comprising:
a first mixer adapted to contain a quantity of first material granules;
a weigh scale adapted to weigh the amount of the first material granules in the first mixer;
means for adding a desired amount of at least one additive to the first mixer to form a batch of a pre-mix of first material granules and the at least one additive, the desired amount of the at least one additive being based on the weight of the first material granules in the first mixer and a predetermined desired weight ratio of the at least one additive to the first material granules;
a storage vessel;
a batch transfer device operably connected at a first end to the first mixer and at a second end to the storage vessel, the batch transfer device adapted to transfer the pre-mix from the first mixer to the storage vessel;
a processing device; and
a continuous feeder operably connected at a first end to the storage vessel and at a second end to the processing device, the continuous feeder adapted to continuously feed the pre-mix from the storage vessel to the processing device at a predetermined rate.

2. The apparatus of claim 1, further comprising:
means for continuously feeding one or more polymer streams to the processing device, each of the polymer streams being fed into the processing device at a rate based on the rate at which the first material granules in the pre-mix are being fed into the processing device and a predetermined desired weight ratio of each polymer to first material granules.

3. The apparatus of claim 2, wherein the one or more polymer streams are selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

4. The apparatus of claim 1, wherein the first material is an elastomer.

5. The apparatus of claim 4, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

6. The apparatus of claim 4, further comprising:
means for feeding at least one vulcanizing agent stream to the processing device, each of the vulcanizing agent streams being fed into the processing device at a rate based on the rate at which the elastomer granules in the pre-mix are being fed into the processing device and a predetermined desired weight ratio of each vulcanizing agent to elastomer granules and wherein the elastomer is at least partially cured after being removed from the processing device.

7. The apparatus of claim 1, wherein the at least one additive is selected from the group consisting of cure agents, vulcanization catalysts, fillers, oils and mixtures thereof.

8. The apparatus of claim 1, wherein the at least one additive is selected from the group consisting of zinc oxide, clay, stannous chloride and mixtures thereof.

9. The apparatus of claim 1, wherein the first mixer is a low-shear mixer and the storage vessel has an effective storage volume greater than that of the first mixer.

10. The apparatus of claim 9, wherein the storage vessel has an effective storage volume at least twice that of the first mixer.

11. The apparatus of claim 9, wherein the first mixer is a drum mixer.

12. The apparatus of claim 1, wherein the continuous feeder is a continuous belt feeder.

13. The apparatus of claim 1, wherein the first material granules have a particle size of about 10 to about 20 millimeters.

14. Apparatus for preparing thermoplastic polymer blends comprising:
a grinder adapted to granulate an elastomer to obtain a quantity of elastomer granules;
a first mixer;
a first material transfer device operably connected at a first end to the grinder and at a second end to the first mixer, the first material transfer device adapted to transfer the elastomer granules from the grinder to the first mixer;
a weigh scale adapted to weigh the amount of the elastomer granules in the first mixer;
means for adding a desired amount of at least one additive to the first mixer to form a batch of a pre-mix of elastomer granules and the at least one additive, the desired amount of the at least one additive being based on the weight of the elastomer granules in the first mixer and a predetermined desired weight ratio of the at least one additive to the elastomer granules;
a second mixer;
a second material transfer device operably connected at a first end to the first mixer and at a second end to the second mixer, the second material transfer device adapted to transfer the individual batches of the pre-mix from the first mixer to the second mixer;
a processing device;
a third material transfer device operably connected at a first end to the second mixer and at a second end to the processing device, the third material transfer device adapted to continuously feed the pre-mix from second mixer to the processing device at a predetermined rate;
means for continuously feeding one or more polymer streams to the processing device, each of the polymer streams being fed into the processing device at a rate based on the rate at which the elastomer granules in the pre-mix are being fed into the processing device and a predetermined desired weight ratio of each polymer to elastomer granules; and
means for feeding at least one vulcanizing agent stream to the processing device, each of the vulcanizing agent streams being fed into the processing device at a rate based on the rate at which the elastomer granules in the pre-mix are being fed into the processing device and a predetermined desired weight ratio of each vulcanizing agent to elastomer granules.

15. The apparatus of claim 14, wherein the one or more polymer streams are selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

16. The apparatus of claim 14, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

17. The apparatus of claim 14, wherein the at least one additive is selected from the group consisting of cure agents, vulcanization catalysts, fillers, oils and mixtures thereof.

18. The apparatus of claim 14, wherein the at least one additive is selected from the group consisting of zinc oxide, clay, stannous chloride and mixtures thereof.

19. The apparatus of claim 14, wherein the first and second mixers are low-shear mixers and the second mixer has an effective storage volume greater than that of the first mixer.

20. The apparatus of claim 18, wherein the first and second mixers are drum mixers.

21. The apparatus of claim 14, wherein the third material transfer device is a continuous belt feeder.

22. The apparatus of claim 14, wherein the particle size of the elastomer granules is from about 10 to about 20 millimeters.

23. The apparatus of claim 14, wherein the at least one vulcanizing agent stream is selected from the group consisting of silicon hydrides, phenolic resins, peroxides, free radical initiators, sulfur, zinc metal compounds and mixtures thereof.

24. Apparatus for preparing thermoplastic elastomers comprising:
a grinder adapted to granulate an elastomer to obtain a quantity of elastomer granules;
a first low-shear, drum mixer;
a first material transfer device operably connected at a first end to the grinder and at a second end to the first low-shear drum mixer, the first material transfer device adapted to transfer the elastomer granules from the grinder to the first low-shear, drum mixer;
a weigh scale adapted to weigh the amount of the elastomer granules in the first low-shear, drum mixer;
means for adding a desired amount of at least one additive to the first low-shear, drum mixer to form a batch of a pre-mix of elastomer granules and the at least one additive, the desired amount of the at least one additive being based on the weight of the elastomer granules in the first low-shear, drum mixer and a predetermined desired weight ratio of the at least one additive to the elastomer granules;
a second low-shear drum mixer with an effective storage volume greater than that of the first low-shear, drum mixer;
a second material transfer device operably connected at a first end to the first low-shear, drum mixer and at a second end to the second low-shear, drum mixer, the second material transfer device adapted to transfer the individual batches of the pre-mix from the first low-shear, drum mixer to the second low-shear, drum mixer;
a processing device;
a third material transfer device operably connected at a first end to the second low-shear, drum mixer and at a second end to the processing device, the third material transfer device adapted to continuously feed the pre-mix from the second low-shear, drum mixer to the processing device at a predetermined rate;
means for continuously feeding one or more polymer streams to the processing device, each of the polymer streams being fed into the processing device at a rate based on the rate at which the elastomer granules in the pre-mix are being fed into the processing device and a predetermined desired weight ratio of each polymer to elastomer granules; and
means for feeding at least one vulcanizing agent stream to the processing device, each of the vulcanizing agent streams being fed into the processing device at a rate based on the rate at which the elastomer granules in the pre-mix are being fed into the processing device and a predetermined desired weight ratio of each vulcanizing agent to elastomer granules.

25. The apparatus of claim 24, wherein the one or more polymer streams are selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

26. The apparatus of claim 24, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

27. The apparatus of claim 24, wherein the at least one additive is selected from the group consisting of zinc oxide, clay, stannous chloride and mixtures thereof.

28. The apparatus of claim 24, wherein the third material transfer device is a continuous belt feeder.

29. The apparatus of claim 24, wherein the particle size of the elastomer granules is from about 10 to about 20 millimeters.

30. The apparatus of claim 24, further comprising:
means for feeding at least one processing agent stream to the processing device, each of the processing agent streams being fed into the processing device at a rate based on the rate at which the elastomer granules in the pre-mix are being fed into the processing device and a predetermined desired weight ratio of each processing agent to elastomer granules.

31. The apparatus of claim 30, wherein the at least one processing agent stream is selected from the group consisting of oils, fillers, plasticizers and mixtures thereof.

32. The apparatus of claim 24, wherein the at least one vulcanizing agent stream is selected from the group consisting of silicon hydrides, phenolic resins, peroxides, free radical initiators, sulfur, zinc metal compounds and mixtures thereof.

33. A process for preparation of thermoplastic polymer blends comprising:
transferring a quantity of first material granules to a first mixer;
determining the weight of the first material granules in the first mixer;
calculating the desired amount of at least one additive based on (i) the weight of the first material granules in the first mixer and (ii) a predetermined desired weight ratio of the at least one additive to the first material granules;
adding the desired amount of the at least one additive to the first material granules in the first mixer;
mixing the first material granules and the at least one additive in the first mixer to obtain a batch of a pre-mix;
transferring the pre-mix from the first mixer to a storage vessel;
continuously feeding the pre-mix from the storage vessel to a processing device;
continuously feeding at least one polymer stream to the processing device, the at least one polymer stream being fed at a rate based on (i) the rate at which the first material granules in the pre-mix are being fed to the processing device and (ii) a predetermined weight ratio of polymer to first material granules; and
continuously blending the pre-mix and the at least one polymer stream in the processing device to form a thermoplastic polymer blend.

34. The process of claim 33, further comprising:
granulating a first material to obtain a quantity of first material granules.

35. The process of claim 33, wherein the at least one polymer stream is selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

36. The process of claim 33, wherein the first material is an elastomer.

37. The process of claim 36, wherein the first material is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

38. The process of claim 33, wherein the at least one additive is selected from the group consisting of cure agents, vulcanization catalysts, fillers, oils and mixtures thereof.

39. The process of claim 33, wherein the at least one additive is selected from the group consisting of zinc oxide, clay, stannous chloride and mixtures thereof.

40. The process of claim 33, wherein the first mixer is a low-shear mixer and the storage vessel has an effective storage volume greater than that of the first mixer.

41. The process of claim 40, wherein the storage vessel has an effective storage volume at least twice that of the first mixer.

42. The process of claim 40, wherein the first mixer is a drum mixer.

43. The process of claim 33, wherein the particle size of the first material granules is from about 10 to about 20 millimeters.

44. The process of claim 33, further comprising:
feeding at least one vulcanizing agent stream to the processing device, the at least one vulcanizing agent stream being fed at a rate based on (i) the rate at which the first material granules in the pre-mix are being fed to the processing device and (ii) a predetermined weight ratio of vulcanizing agent to first material granules.

45. The process of claim 44, wherein the at least one vulcanizing agent stream is selected from the group consisting of silicon hydrides, phenolic resins, peroxides, free radical initiators, sulfur, zinc metal compounds and mixtures thereof.

46. The process of claim 44, wherein the first material is an elastomer and further comprising:
heating the thermoplastic polymer blend in the processing device to obtain an at least partially-cured thermoplastic elastomer.

47. The process of claim 33, further comprising:
feeding at least one processing agent stream to the processing device, the at least one processing agent stream being fed at a rate based on (i) the rate at which the first material granules in the pre-mix are being fed to the processing device and (ii) a predetermined weight ratio of processing agent to first material granules.

48. The process of claim 47, wherein the at least one processing agent stream is selected from the group consisting of oils, fillers, plasticizers and mixtures thereof.

49. A process for preparation of thermoplastic polymer blends comprising:
granulating a first material to obtain a quantity of first material granules;
transferring the first material granules to a first mixer;
determining the weight of the first material granules in the first mixer;
calculating the desired amount of at least one additive based on (i) the weight of the first material granules in the first mixer and (ii) a predetermined desired weight ratio of the at least one additive to the first material granules;
adding the desired amount of the at least one additive to the first material granules in the first mixer;
mixing the first material granules and the at least one additive in the first mixer to obtain a batch of a pre-mix;
transferring the batch of the pre-mix from the first mixer to a second mixer, the second mixer having an effective storage volume greater than that of the first mixer;
mixing the pre-mix in the second mixer;
continuously feeding the pre-mix from the storage vessel to a processing device;
continuously feeding at least one polymer stream to the processing device, the at least one polymer stream being fed at a rate based on (i) the rate at which the first material granules in the pre-mix are being fed to the processing device and (ii) a predetermined weight ratio of polymer to first material granules; and
continuously blending the pre-mix and the at least one polymer stream in the processing device to form a thermoplastic polymer blend.

50. The process of claim 49, wherein the at least one polymer stream is selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

51. The process of claim 49, wherein the first material is an elastomer.

52. The process of claim 51, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

53. The process of claim 49, wherein the at least one additive is selected from the group consisting of cure agents, vulcanization catalysts, fillers, oils and mixtures thereof.

54. The process of claim 49, wherein the at least one additive is selected from the group consisting of zinc oxide, clay, stannous chloride and mixtures thereof.

55. The process of claim 49, wherein the first mixer is a low-shear mixer.

56. The process of claim 49, wherein the second mixer is a low-shear mixer.

57. The process of claim 49, wherein the second mixer has an effective storage volume at least twice that of the first mixer.

58. The process of claim 49, wherein either or both of the first and second mixers is a drum mixer.

59. The process of claim 49, wherein the particle size of the first material granules is from about 10 to about 20 millimeters.

60. The process of claim 49, further comprising:
feeding at least one vulcanizing agent stream to the processing device, the at least one vulcanizing agent stream being fed at a rate based on (i) the rate at which the first material granules in the pre-mix are being fed to the processing device and (ii) a predetermined weight ratio of vulcanizing agent to first material granules.

61. The process of claim 60, wherein the at least one vulcanizing agent stream is selected from the group consisting of silicon hydrides, phenolic resins, peroxides, free radical initiators, sulfur, zinc metal compounds and mixtures thereof.

62. The process of claim 61, wherein the first material is an elastomer and further comprising:
heating the thermoplastic polymer blend in the processing device to obtain an at least partially-cured thermoplastic elastomer.

63. The process of claim 49, further comprising:
feeding at least one processing agent stream to the processing device, the at least one processing agent stream being fed at a rate based on (i) the rate at which the first material granules in the pre-mix are being fed to the processing device and (ii) a predetermined weight ratio of processing agent to first material granules.

64. The process of claim 63, wherein the at least one processing agent stream is selected from the group consisting of oils, fillers, plasticizers and mixtures thereof.

65. A process for preparation of thermoplastic elastomer blends comprising:
granulating an elastomer to obtain a quantity of elastomer granules;
transferring the elastomer granules to a first low-shear mixer;
determining the weight of the elastomer granules in the first low-shear mixer;
calculating the desired amount of at least one additive based on (i) the weight of the elastomer granules in the first low-shear mixer and (ii) a predetermined desired weight ratio of the at least one additive to the elastomer granules;
adding the desired amount of the at least one additive to the elastomer granules in the first low-shear mixer;
mixing the elastomer granules and the at least one additive in the first low-shear mixer to obtain a batch of a pre-mix;
transferring the batch of the pre-mix from the first low-shear mixer to a storage vessel, the storage vessel having an effective storage volume greater than that of the first low-shear mixer;
continuously feeding the pre-mix from the storage vessel to a processing device;
continuously feeding at least one polymer stream into the processing device, the at least one polymer stream being fed into the processing device at a rate based on (i) the rate at which the elastomer granules in the pre-mix are being fed into the processing device and (ii) a predetermined desired weight ratio of polymer to elastomer granules;
continuously blending the pre-mix and the at least one polymer stream in the processing device to form a thermoplastic polymer blend;
adding an effective amount of at least one vulcanizing agent into the processing device; and
continuously blending and heating the thermoplastic polymer mix and the at least one vulcanizing agent in the processing device to form an at least partially-cured thermoplastic elastomer.

66. The process of claim 65, wherein the at least one polymer stream is selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

67. The process of claim 65, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

68. The process of claim 65, wherein the at least one additive is selected from the group consisting of cure agents, vulcanization catalysts, fillers, oils and mixtures thereof.

69. The process of claim 65, wherein the at least one additive is selected from the group consisting of zinc oxide, clay, stannous chloride and mixtures thereof.

70. The process of claim 65, wherein the storage vessel has an effective storage volume at least twice that of the first mixer.

71. The process of claim 65, wherein the first mixer is a drum mixer.

72. The process of claim 65, wherein the storage vessel is a second low-shear mixer.

73. The process of claim 65, wherein the particle size of the elastomer granules is from about 10 to about 20 millimeters.

74. The process of claim 65, further comprising:
feeding at least one processing agent stream to the processing device, the at least one processing agent stream being fed at a rate based on (i) the rate at which the elastomer granules in the pre-mix are being fed to the processing device and (ii) a predetermined weight ratio of processing agent to elastomer granules.

75. The process of claim 74, wherein the at least one processing agent stream is selected from the group consisting of oils, fillers, plasticizers and mixtures thereof.

76. The process of claim 65, wherein the at least one vulcanizing agent stream is selected from the group consisting of silicon hydrides, phenolic resins, peroxides, free radical initiators, sulfur, zinc metal compounds and mixtures thereof.

77. An apparatus for preparing thermoplastic elastomer blends comprising:
grinding means for granulating an elastomer to obtain a quantity of elastomer granules;
mixing means for mixing the elastomer granules and at least one additive to form a pre-mix;
first transferring means for transferring the elastomer granules from the grinding means to the mixing means;
weighing means for determining the weight of the elastomer granules transferred to the mixing means;
means for adding a desired amount of the least one additive to the mixing means to form a batch of pre-mix, the desired amount of the at least one additive being based on the weight of the elastomer granules in the mixing means and a predetermined desired weight ratio of the at least one additive to the elastomer granules;
storage means for storing the pre-mix;
second transferring means for transferring the batch of the pre-mix from the mixing means to the storage means;
processing means for blending the pre-mix with at least one polymer stream;
third transferring means for continuously transferring the pre-mix from the storage means to the processing means;
polymer feeding means for continuously feeding at least one polymer stream into the processing means at a rate based on (i) the rate at which the third transferring means transfers the elastomer granules in the pre-mix from the storage means to the processing means and (ii) a predetermined desired weight ratio of polymer to elastomer granules;
vulcanizing agent feeding means for feeding at least one vulcanizing agent into the processing means at a rate based on (i) the rate at which the third transferring means transfers the elastomer granules in the pre-mix from the storage means to the processing means and (ii) a predetermined desired weight ratio of vulcanizing agent to elastomer granules; and
heating means for heating the pre-mix and polymer in the processing means during processing.

78. The apparatus of claim 77 further comprising:
processing agent feeding means for feeding at least one processing agent into the processing means at a rate based on (i) the rate at which the third transferring means transfers the elastomer granules in the pre-mix from the storage means to the processing means and (ii) a predetermined desired weight ratio of processing agent to elastomer granules.

79. The process of claim 78, wherein the at least one processing agent stream is selected from the group consisting of oils, fillers, plasticizers and mixtures thereof.

80. A process for preparation of thermoplastic elastomer compositions comprising:
(a) preparing individual batches of an elastomeric pre-mix by
(i) granulating an elastomer to obtain a quantity of elastomer granules,
(ii) transferring the elastomer granules to a first low-shear mixer,
(iii) determining the weight of the elastomer granules in the first low-shear mixer,
(iv) calculating the desired amount of at least one additive based on (A) the weight of the elastomer granules in the first low-shear mixer and (B) a predetermined desired weight ratio of the at least one additive to the elastomer granules,
(v) adding the desired amount of the at least one additive to the elastomer granules in the first low-shear mixer,
(vi) mixing the elastomer granules and the at least one additive in the first low-shear mixer to obtain a batch of elastomer pre-mix,
(vii) transferring the batch of elastomer pre-mix from the first low-shear mixer to a storage vessel, the storage vessel having an effective storage volume greater than that of the first low-shear mixer, and
(viii) repeating steps (a)(i) through (a)(vii) to prepare additional batches of elastomer pre-mix;
(b) continuously feeding the elastomer pre-mix from the storage vessel to a processing device;
(c) continuously feeding a polymer stream into the processing device, the polymer stream being fed into the processing device at a rate based on (A) the rate at which the elastomer granules in the elastomer pre-mix are being fed into the processing device and (B) a predetermined desired weight ratio of polymer to elastomer granules;
(d) blending the pre-mix and the polymer stream in the processing device to form a thermoplastic polymer composition;
(e) adding an effective amount of at least one vulcanizing agent into the processing device; and
(f) blending and heating the thermoplastic polymer composition and the at least one vulcanizing agent in the processing device to form an at least partially-cured thermoplastic elastomer.

81. The process of claim 80, wherein the at least one polymer stream is selected from the group consisting of crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

82. The process of claim 80, wherein the elastomer is selected from the group consisting of EPR rubber, EPDM rubber, butyl rubber, homopolymers of at least one conjugated diene with an aromatic monomer, copolymers of at least one conjugated diene with an aromatic monomer, copolymers of at least one conjugated diene with a polar monomer, unsaturated non-polar elastomers, natural rubber, polyisoprene, polybutadiene elastomer, styrene-butadiene elastomer and mixtures thereof.

83. The process of claim 80, wherein the at least one additive is selected from the group consisting of cure agents, vulcanization catalysts, fillers, oils and mixtures thereof.

84. The process of claim 75, wherein the at least one additive is selected from the group consisting of zinc oxide, clay, stannous chloride and mixtures thereof.

85. The process of claim 80, wherein the storage vessel has an effective storage volume at least twice that of the first low-shear mixer.

86. The process of claim 80, wherein the first low-shear mixer is a drum mixer.

87. The process of claim 80, wherein the storage vessel is a second low-shear mixer.

88. The process of claim 80, wherein the particle size of the elastomer granules is from about 10 to about 20 millimeters.

89. The process of claim 80, wherein the at least one vulcanizing agent is selected from the group consisting of silicon hydrides, phenolic resins, peroxides, free radical initiators, sulfur, zinc metal compounds and mixtures thereof.
